(19) United States
(12) Patent Application Publication
(10) Pub. No.: US 2007/0201131 A1
(43) Pub. Date: Aug. 30, 2007

(54) Diffusing Sheet And Rear Projection Screen

(75) Inventor: Yuki Katsura, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-ku,Tokyo-to (JP)

(21) Appl. No.: 10/592,415

(22) PCT Filed: Nov. 22, 2005
(86) PCT No.: PCT/JP05/21447

§ 371 Date: Sep. 11, 2006

(30) Foreign Application Priority Data
Nov. 25, 2004 (JP) 2004-340463

(51) Int. Cl. G03B 21/60; G03B 21/56

(52) U.S. Cl. 359/460; 359/456

(57) ABSTRACT

A diffusing sheet is glossy and is capable of displaying images in satisfactory contrast and a rear projection screen includes the diffusing sheet. A diffusing sheet 11 has an exit surface 12 facing the viewer and an entrance surface 13. The exit surface 12 meets a condition that a value obtained by dividing a value obtained through the discrete Fourier transform of roughness data obtained by measuring the surface roughness of the exit surface by the number of data is 0.04 μm or below for frequencies of 80 mm⁻¹ or above. Preferably, the exit surface 12 of the diffusing sheet 11 has an arithmetical average roughness Ra of 0.50 μm or below.

### TECHNICAL FIELD

The present invention relates to a diffusing sheet for a rear projection screen that transmits imaging light and a rear projection screen provided with the diffusing sheet. More specifically, the present invention relates to a glossy diffusing sheet capable of displaying a high-contrast image and a rear projection screen provided with the diffusing sheet.

### BACKGROUND ART

A projection television, namely, a rear projection display, includes, as essential components, a light source, and a rear projection screen on which an optical image projected by the light source is displayed in an enlarged image. Generally, the rear projection screen has a Fresnel lens sheet that deflects optical image projected by the light source into parallel or substantially parallel light rays (hereinafter referred to as “substantially parallel light rays”) traveling toward a television viewer, and a diffusing sheet for diffusing the light rays to increase image viewing angle. Known diffusing sheets include lenticular lens sheets disclosed in, for example, Patent documents 1 and 2 that diffuse substantially parallel incident light rays horizontally by the refracting effect of lenticular lenses, and a diffusing sheet disclosed in, for example, Patent document 3 that diffuses substantially parallel incident light rays horizontally by the agency of the light guide function of a total reflection surface.

The surface of such a rear projection screen is coated with an antireflection layer or small irregularities are formed therein by a frosting process to reduce the reflection of external light in the surface of the rear projection screen. A three-tube CRT light source including three CRTs respectively for emitting light beams of three primary colors is used generally as the light source. Recently, Single-tube light sources employing an LCD or a DLP have been used to cope with a demand for high-definition images.

Patent document 1: Jpn. Pat. No. 35070 (FIG. 3)

Patent document 2: JP 2004-47329 A (FIG. 1)

Patent document 3: JP 2004-4148 (FIGS. 1 and 11)

### DISCLOSURE OF THE INVENTION

### Problem to be Solved by the Invention

When an LCD or a DLP is employed to cope with a demand for high-definition images, the surface of a conventional rear projection screen coated with an antireflection layer or provided with small irregularities looks as if the surface of the rear projection screen is covered with a net and deteriorates the quality of images. Images displayed on the conventional rear projection screen have a low contrast, become whitish under bright light and are unsatisfactory in sharpness.

The surface of a diffusing sheet included in a known rear projection screen a specific surface roughness Ra. However, some problems can be solved and some other problems cannot be solved by properly adjusting the surface roughness. It was found that problems in glossiness and contrast cannot be satisfactorily solved merely by adjusting the surface roughness.

The present invention has been made to solve those problems and it is therefore an object of the present invention to provide a glossy diffusing sheet capable of diffusing light so that images can be displayed in satisfactory contrast and to provide a rear projection screen provided with the same diffusing sheet.

### Means for Solving the Problem

The inventors of the present invention examined the foregoing problems from various points of view and found that even rear projection screen having the same surface roughness the appearance thereof is greatly dependent on the pitches of irregularities in the surface. A diffusing sheet according to the present invention for a rear projection screen has an exit surface facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above.

The diffusing sheet of the present invention having the exit surface meeting a condition that a value obtained by dividing a value obtained through the discrete Fourier transform of roughness data obtained by measuring the surface roughness of the exit surface by the number of data is 0.4 μm or below for frequencies of 80 mm⁻¹ or above is glossy and has an effect of displaying images in satisfactory contrast.

The diffusing sheet according to the present invention is characterized in that the exit surface has an arithmetical average roughness Ra of 0.50 μm or below. The diffusing sheet of the present invention has an effect of controlling the reflection of external light in the exit surface.

The diffusing sheet according to the present invention has the exit surface coated with a transparent layer and the roughness data is obtained by measuring the roughness of the transparent layer. According to the present invention, the roughness data is obtained by measuring the surface roughness of the transparent layer, and the rear projection screen provided with the diffusing sheet is glossy and is capable of displaying images in satisfactory contrast.

The diffusing sheet according to the present invention is characterized in that at least either of a layer including the exit surface and a layer contiguous with the former layer contains a diffusing material. Preferably, the surface roughness of the exit surface is determined by the diffusing material contained in at least a layer including the exit surface or a layer contiguous with the former layer.

The diffusing sheet according to the present invention includes a support member having the exit surface, and a diffusing member attached to the entrance surface of the support member opposite the exit surface. The diffusing member of the diffusing sheet may be provided with transparent parts and screening strips in an alternate arrangement on the exit surface thereof facing the support member, and provided with lenses for focusing substantially parallel incident light rays falling in a direction parallel to a normal to the diffusing member in the vicinity of the transparent parts on the entrance surface thereof opposite the exit surface thereof or may be provided with light absorbing parts of a substantially V-shaped cross section each having a first inclined surface and a second inclined surface, formed in the exit surface thereof contiguous with the support member and tapering toward the entrance surface thereof, and parts thereof other than the light absorbing parts have a refractive index higher than that of the light absorbing parts, and the first and the second inclined surfaces may serve as light guides for totally reflecting substantially parallel incident light rays fallen on the entrance surface.

A rear projection screen according to the present invention includes the foregoing diffusing sheet according to the present invention. Since the rear projection screen of the present invention includes the diffusing sheet having the exit surface facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above, the rear projection screen is glossy and can display images in satisfactory contrast.

### Effect of the Invention

As apparent from the foregoing description, the diffusing sheet and the rear projection screen according to the present invention meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above is glossy and can display images in satisfactory contrast. A rear projection display provided with a diffusing sheet like that of the present invention can control the reflection of external light in the surface of the rear projection screen and can display images on the glossy rear projection screen in satisfactory contrast.

### BRIEF DESCRIPTIN OF THE DRAWINGS

FIG. 1(A) is a typical sectional view of a diffusing sheet in a first embodiment according to the present invention;

FIG. 1(B) is a typical perspective view of a diffusing member by way of example;

FIG. 2 is a graph showing a surface roughness curve representing measured surface roughness data on a surface of the diffusing sheet;

FIG. 3 is a graph showing a curve representing data obtained through the discrete Fourier transform of the measured surface roughness data;

FIG. 4(A) is a typical sectional view of a diffusing sheet in a second embodiment according to the present invention;

FIG. 4(B) is a typical perspective view of a diffusing member by way of example;

FIG. 5(A) is a typical sectional view of a diffusing sheet in a third embodiment according to the present invention;

FIG. 5(B) is a typical sectional view of a diffusing sheet in a modification of the diffusing sheet shown in FIG. 5(A);

FIG. 6 is a typical sectional view of a diffusing sheet in a fourth embodiment according to the present invention;

FIG. 7 is a typical sectional view of a diffusing sheet in a fifth embodiment according to the present invention;

FIG. 8 is a typical sectional view of a diffusing sheet in a sixth embodiment according to the present invention;

FIG. 9(A) is a typical perspective view of a rear projection screen according to the present invention provided with a refraction Fresnel lens sheet having its center in a plane containing the Fresnel lens sheet;

FIG. 9(B) is a typical perspective view of a rear projection screen according to the present invention provided with a total reflection Fresnel lens sheet having its center outside a plane containing the Fresnel lens sheet;

FIG. 10(A) is a typical side elevation of a rear projection display provided with a rear projection screen according to the present invention including a refraction Fresnel lens sheet having its center in a plane containing the Fresnel lens sheet;

FIG. 10(B) is a typical side elevation of a rear projection display provided with a rear projection screen according to the present invention including a total reflection Fresnel lens sheet having its center outside a plane containing the Fresnel lens sheet;

FIG. 11 is a graph showing surface roughness curves representing surface roughnesses of the diffusing sheet embodying the present invention and diffusing sheets in comparative examples; and

FIG. 12 is a graph showing curves representing values obtained through the discrete Fourier transform of the surface roughness data shown in FIG. 11.

### BEST MODE FOR CARRYING OUT THE INVENTION

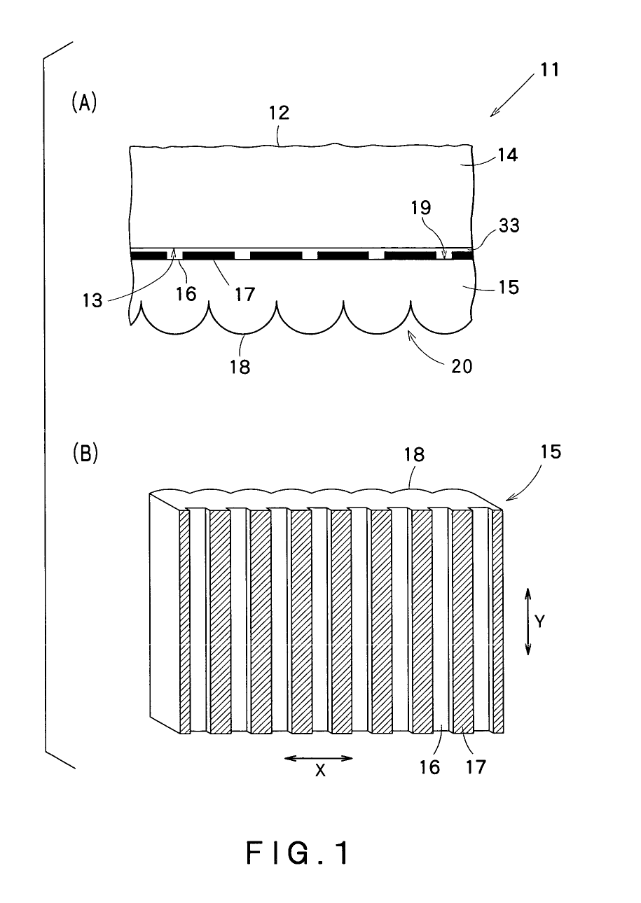

Diffusing sheets and rear projection screens according to the present invention will be described with reference to the accompanying drawings. Unless otherwise specified, sectional views are those taken in a plane parallel to the thickness of the diffusing sheets as a component of a rear projection screen. In FIGS. 1(A), 4(A) and 5 to 8, irregular surfaces of support members and diffusing materials contained in the support members or transparent layers are not shown in actual dimensions and are exaggerated.

A diffusing sheet according to the present invention is characterized by an exit surface thereof facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Diffusing sheet each having such an exit surface facing the viewer will be described.

### Diffusing Sheet in First Embodiment

FIG. 1(A) is a typical sectional view of a diffusing sheet 11 in a first embodiment according to the present invention. Referring to FIG. 1(A), the diffusing sheet 11 has a support member 14 having an exit surface 12 facing the viewer, and a diffusing member 15 attached to an entrance surface 13, namely, a surface on the side of a light source.

The support member 14 prevents the transparent, comparatively thin diffusing member 15 fro warpoing and deforming. The support member 14 is a transparent or semitransparent sheet, such as a sheet made of a resin for forming a transparent optical sheet for a display or a glass substrate. Transparent materials suitable for forming the support member 14 are thermoplastic resins such as acrylic resins, polycarbonate resins, vinyl chloride resins, styrene resins, cellulose resins and cycloolefin resins. It is desirable to select a material taking into consideration resistance to weathe4ring and scratching in addition to transparency and rigidity. The support member 14 is formed by, for example extruding suitable one of the foregoing resins by an extruding machine. Transparency and rigidity are taking into consideration in determining the thickness of the support member 14. Usually, the thickness of the support member 14 is between 1 and 5 mm.

The diffusing sheet 11 has the exit surface 12 facing the viewer and an entrance surface 20. The diffusing sheet 11 is characterized by the exit surface 12 meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above.

According to the present invention, surface roughness is measured by a surface roughness measuring method specified in B 0601-2001 JIS (ISO 4282-1997) using a contact profile meter and measured surface roughness data is subjected to discrete Fourier transform.

Discrete Fourier transform is expressed by a known discrete Fourier transform formula shown below. A complex Fourier series X(i) (i=0, 1, 2, . . . , N−1) is calculated by using Expression (2) when a sequence of N pieces of data is expressed by Expression (1), in which Tₛ is sampling period.
Expression (1) (1)
Expression (2) (1)

When a complex Fourier series X(i) is given, an original data sequence x(n) (n=1, 2, . . . , N−1) is calculated by using Expression (3)
Expression (3) (3)

A Fourier spectrum |X(i)| (I=0, 1, 2, . . . N−1) is calculated from the complex Fourier series X(i) by using Expressions (4) and (5). About half of the components of the Fourier spectrum are independent and are components of frequencies i/(N·Tₛ) (i=0, 1, 2, . . . , N/2) including dc components. The frequency in |x(i)| is expressed by i/(measuring length). Measuring length is data sampling length.
Expression (4) (4)
Expression (5) (5)

The present invention converts measured data represented by a surface roughness curve, namely, a discrete progression x(n) (n=0, 1, 2, . . . , N−1) by the discrete Fourier conversion formula using Expressions (4) and (5).

The conversion provides a progression of absolute values of values obtained by multiplying the measured surface roughness data by the sine function and the cosine function.

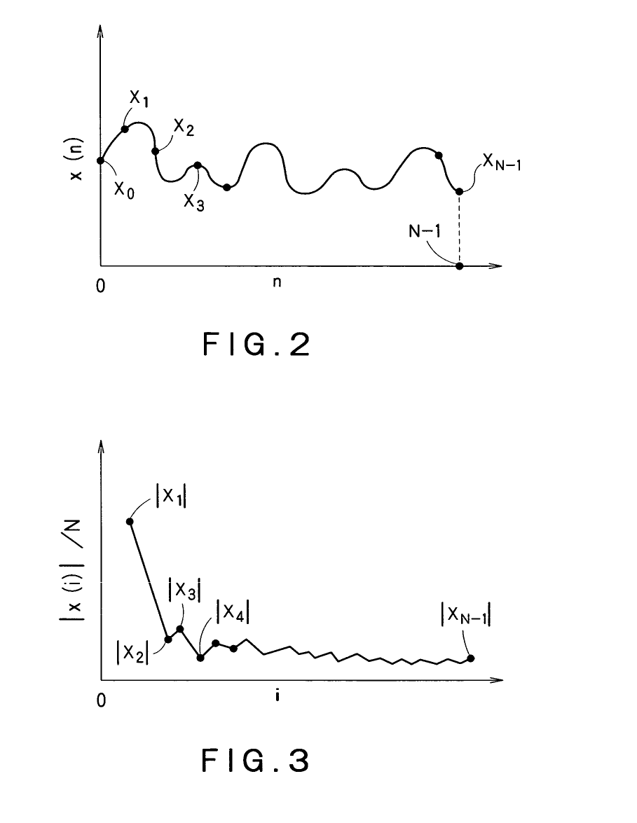

FIG. 2 is a graph showing a surface roughness curve representing measured surface roughness data on a surface of the diffusing sheet. In FIG. 2, measured height x(n) of the n-th point is measured on the vertical axis. FIG. 3 is a graph showing a curve representing data obtained through the discrete Fourier transform of the measured surface roughness data. In FIG. 3, the number i of irregularities in a sampling range is measured on the horizontal axis. Frequency (mm⁻¹) is obtained by dividing the number I by sampling length; that is, (Frequency (mm⁻¹))=i/(Sampling length (mm)). A value |X(i)|/N (μm), i.e., a values obtained by dividing a strength |X(i)|after Fourier transform by the number N of data represents the size of an irregularity. Therefore, (1) a small value obtained by dividing the strength by the number of data in a low-frequency region indicates that there are not many irregularities arranged at long pitches, (2) a large value obtained by dividing the strength by the number of data in a low-frequency region indicates that there are many irregularities arranged at long pitches, (3) a small value obtained by dividing the strength by the number of data in a high-frequency region indicates that there are not many irregularities arranged at short pitches and (4) a large value obtained by dividing the strength by the number of data in a high-frequency region indicates that there are many irregularities arranged at long pitches.

As mentioned above, the exit surface 12 of the diffusing sheet 11 of the present invention meets a condition that a value obtained by dividing a value obtained through the discrete Fourier transform of roughness data obtained by measuring the surface roughness of an optional part of the exit surface 12 by the number of data is 0.04 μm or below for frequencies of 80 mm⁻¹ or above. Therefore, the value of (Strength)/(Number of data) is small at least in a high-frequency region, which indicates that the exit surface 12 does not have many irregularities arranged at short pitches. The diffusing sheet 11 having the exit surface 12 of such a characteristic is glossy and is capable of displaying images in satisfactory contrast. The value of (Strength)/(Number of data) is 0.004 μm or below for frequencies of 80 mm⁻¹ or above. Therefore, the diffusing sheet 11 is glossy and is capable of displaying images in satisfactory contrast regardless of the arithmetical average roughness Ra of the exit surface 12 facing the viewer, provided that the arithmetical average roughness Ra of the exit surface 12 of the diffusing sheet 11 is within a practically acceptable range of 0 to 1 μm (0 μm≦Ra≦1 μm).

The present invention is effective when a value obtained by dividing a value obtained through the discrete Fourier transform of roughness data obtained by measuring the surface roughness of the exit surface 12 by the number of data is 0.04 μm or below for frequencies of 80 mm⁻¹ or above. The value thus obtained may be, for example, 0.

The related art mentioned in the patent document described in the description of the background art attempts to improve the ability of the rear projection screen to display images in satisfactory contrast by specifying a specific range for the arithmetical average roughness Ra indicate a surface roughness. Arithmetical average roughness Ra is a parameter indicating only the height of irregularities in the surface and does not take into consideration the period of irregularities (the reciprocal of the frequency) at all. Therefore, the exit surfaces of rear projection screens having the same arithmetical average roughness Ra and having irregularities of different periods have different appearances, respectively. A diffusing sheet not having many short-period irregularities and having long-period irregularities form the exit surface of the screen in a flat, glossy surface (surface like a glare). In such a case, black intensifies the sharpness of the appearance when a lenticular lens sheet (diffusing member 15) provided with a pattern of screening strips 17 is attached to the entrance surface 13 (entrance surface) of the support member 14 as shown in FIG. 1(A). The exit surface of a diffusing sheet having short-period irregularities have a fine, matte appearance and is not glossy.

The diffusing member 15 is a transparent or semitransparent sheet. As shown in FIG. 1(A), transparent parts 16 and screening strips 17 (hereinafter referred to as “BS strips 17”) are formed alternately on the exit surface 19, to be joined to the support member 14, of the diffusing member 15. Lenses 18 are formed on the entrance surface 20, opposite the exit surface 19, of the diffusing member 15. The lenses 18 are lenticular lenses that focus substantially parallel, incident light rays falling on the diffusing member 15 in a direction parallel to a normal to the diffusing member 15 at positions in the vicinity of the transparent parts 16. Usually, the lenses 18, namely, the lenticular lenses, are longitudinally elongate cylindrical lenses respectively having convex entrance surfaces. The longitudinally extending lenses 18 are parallel to a Y-direction and are arranged in an X-direction perpendicular to the Y-direction.

The diffusing member 15 is made of a resin that is used for forming a transparent optical sheet for a display or the like. The resin is, for example, a thermoplastic resin. Preferably, the resin is a thermoplastic resin that transmits electromagnetic waves, such as electron beams (EBs) and ultraviolet rays (UV rays). Particularly desirable resins for forming the diffusing member 15 include acrylic resins, methacrylic resins and copolymers each of a methacrylic resin and a styrene resin.

The diffusing member 15 may be a single-layer structure or a two-layer structure. The thickness of the diffusing sheet 15 is determined taking into consideration the pitches of the lenses 18, focal length and a desired viewing angle.

The BS strips 17 are screening strips formed on the flat exit surface of the diffusing member on the side of the support member 14 in areas other than those on optical paths of incident light rays fallen on the lenses 18. The BS strips 17 intercept or absorb external light fallen on the exit surface of the diffusing sheet 11 to improve the contrast of an image formed on the diffusing sheet 11. The BS strips 17 are formed by any one of known methods. The width and the thickness of the BS strips 17 are optional.

The transparent parts 16 are parts of the exit surface of the diffusing member 15 resembling stripes extending between the adjacent BS strips 17. The transparent parts 16 correspond to the lenses 18, respectively. The transparent parts 16 are on the optical paths, including the optical axes of the lenses 18, of substantially parallel light rays falling on the diffusing member 15 in a direction substantially parallel to a normal to the diffusing member 15. The BS strips 17 and the transparent parts 16 are arranged alternately in a horizontal direction.

The diffusing member 15 is bonded to the support member 14 with, for example, an adhesive 33.

The diffusing sheet 11 in the first embodiment has the exit surface facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Thus the diffusing sheet 11 is glossy and is capable of displaying images in satisfactory contrast.

### Diffusing Sheet in Second Embodiment

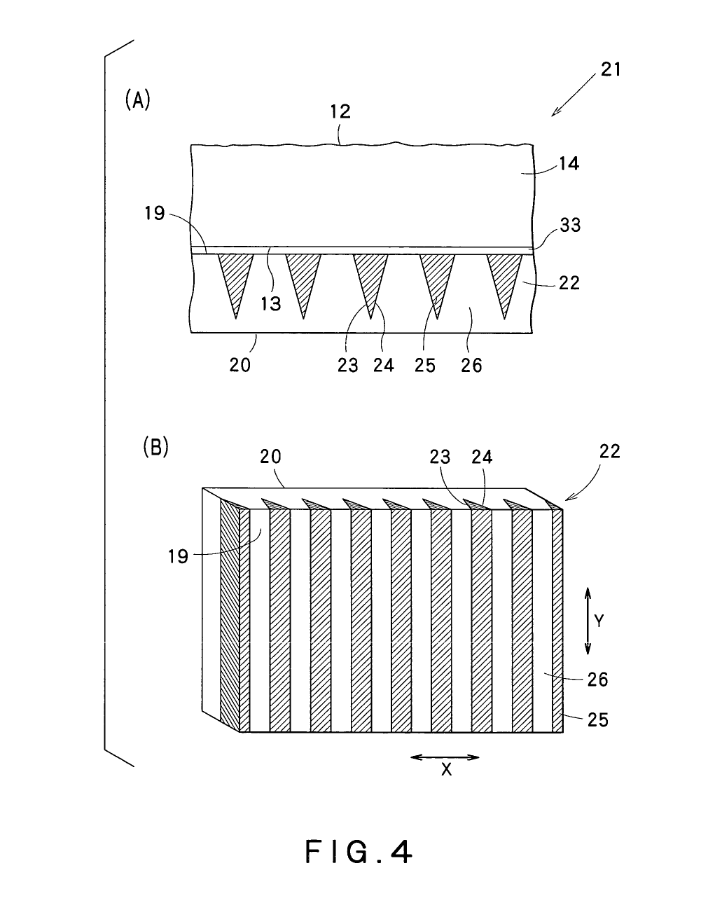

FIG. 4 is a typical sectional view of a diffusing sheet 21 in a second embodiment according to the present invention. As shown in FIG. 4(A), the diffusing sheet 21 in the second embodiment is provided with a diffusing member 22 having a light guide function instead of the diffusing member 15 of the diffusi8ng sheet 11 in the first embodiment.

As shown in FIG. 4(B), the diffusing member 22 is provided with light absorbing parts 25 of a substantially V-shaped cross section each having a first inclined surface 23 and a second inclined surface 24, formed in the exit surface 19 thereof contiguous with a support member 14 and tapering toward the entrance surface 20 thereof. Parts 26 other than the light absorbing parts 25 of the diffusing member 22 have a refractive index higher than that of the light absorbing parts 25. The first inclined surface 23 and the second inclined surface 24 reflect substantially parallel light rays fallen on the entrance surface 20 in a total reflection mode to guide the light rays. For example, the diffusing member mentioned in Patent document 3 (JP 2004-4148) may be employed as the diffusing member 22.

The light diffusing member 22 is can be made by forming a sheet provided with V grooves of a substantially V-shaped cross section by a known method, such as a hot pressing method. a thermal polymerization method or a radiation curing method, using a mold and filling up the V grooves of the sheet with a resin containing light absorbing particles by a filling method, such as a wiping method. Materials suitable for forming the diffusing member 22 are similar to those mentioned above for forming the diffusing member 15 in the first embodiment. Radiation-curable resins are particularly preferable. A radiation-curable resin chosen from those generally used in the relevant field may be used. Suitable radiation-curable resins are, for example, ultraviolet-curable resins and electron radiation-curable resins, such as acrylic resins, epoxy resins and urethane resins. The diffusing member 22 may be a two-layer structure. A two-layer diffusing sheet can be made by forming a radiation-curable resin layer provided with V grooves having a substantially V-shaped cross section on a transparent film or sheet, such as a polyester film or a polycarbonate film, and filling up the V grooves with a resin containing light absorbing particles.

Preferably, the light absorbing parts 25 of a substantially V-shaped cross section have an achromatic color, such as black or grey. However, the color of the light absorbing parts 25 is not limited to an achromatic color. The light absorbing parts 25 may be made of a resin determined by taking into consideration characteristic of light images and capable of selectively absorbing light waves of specific wavelengths. Suitable materials as the light absorbing particles contained in the light absorbing parts 25 include carbon black, graphite, metal salts, such as black iron oxide, colored organic particles and colored glass beads. Suitable coloring dyes are xanthene organic dyes, such as acid red, organic neodymium, such as neodymium carboxylate.

The diffusing sheet 21 in the second embodiment, similarly to the diffusing sheet 11 in the first embodiment, has the exit surface facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Thus the diffusing sheet 21 is glossy and is capable of displaying images in satisfactory contrast.

### Diffusing Sheet in Third Embodiment

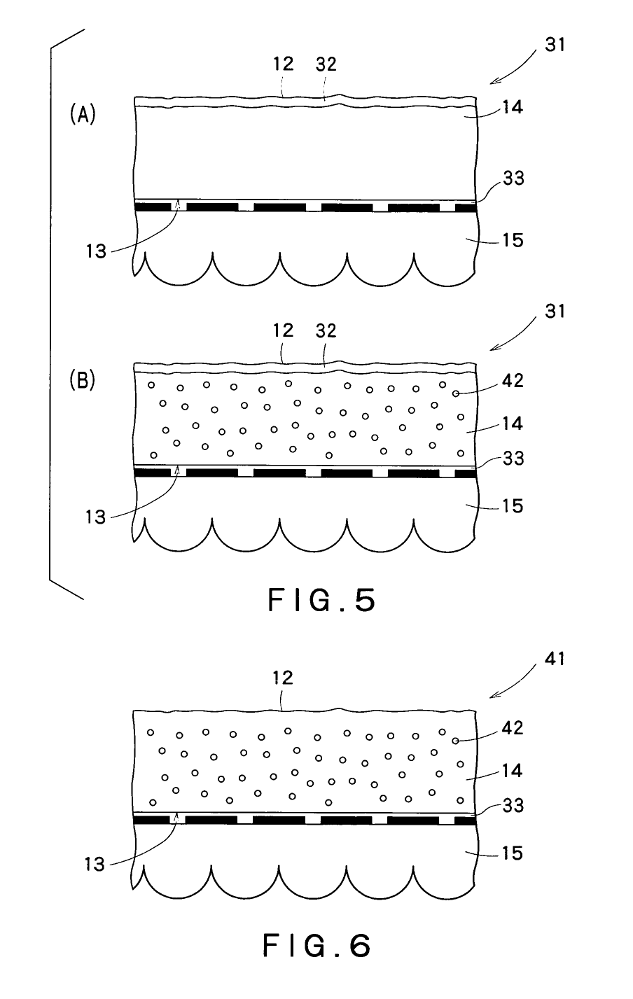

FIG. 5(A) is a typical sectional view of a diffusing sheet 31 in a third embodiment according to the present invention. The diffusing sheet 31 is similar to the diffusing sheet 11 in the first embodiment and the diffusing sheet 21 in the second embodiment. The diffusing sheet 31 in the third embodiment is provided with a transparent layer 32 facing the viewer and having an exit surface 12 meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Measurement of the surface roughness of the transparent layer 32 and the discrete Fourier transform of measured data are the same as those mentioned in connection with the description of the diffusing sheets in the first and the second embodiment. FIG. 5(B) shows a diffusing sheet 31 in a modification of the diffusing sheet 31 shown in FIG. 5(A). The diffusing sheet 31 shown in FIG. 5(B) has a support member 14 containing diffusing material 42.

Preferably, the transparent layer 32 is formed by coating the exit surface of the support member 14 with a radiation-curable resin. The radiation-curable resin may be chosen from generally used materials for forming a transparent layer. Suitable resins for forming the transparent layer 32 are ultraviolet-curable resins and electron radiation-curable resins, such as acrylic resins, epoxy resins and urethane resins, and electron. Preferably, the thickness of the transparent layer 32 is between 5 and 20 μm.

The transparent layer 32 may be functional layer having various functions. For example, the transparent layer 32 may be an antireflection layer, a hard coating layer, antistatic layer, a glare-proof layer a stain-proof layer, a polarizing filter layer or an electromagnetic shielding layer.

The diffusing sheet 31 in the third embodiment, similarly to the diffusing sheet 11 in the first embodiment and the diffusing sheet 21 in the second embodiment, has the exit surface 12 of the transparent layer 32 facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Thus the diffusing sheet 21 is glossy and is capable of displaying images in satisfactory contrast.

### Diffusing Sheet in Fourth Embodiment

FIG. 6 is a typical sectional view of a diffusing sheet 41 in a fourth embodiment according to the present invention. The diffusing sheet 41 is similar to the diffusing sheet 11 in the first embodiment and the diffusing sheet 21 in the second embodiment. The diffusing sheet 41 in the fourth embodiment is characterized by a support member 41 containing a diffusing material 42. Measurement of the surface roughness of the exit surface 12 of the support member 14 and the discrete Fourier transform of measured data are the same as those mentioned in connection with the description of the diffusing sheets in the first and the second embodiment.

When a diffusing member 15 included in the diffusing sheet 41 controls horizontal viewing angle, the diffusing material 42 controls vertical viewing angle. The diffusing material 42 may be a diffusing material contained in general optical sheets. Suitable diffusing materials are, for example, organic particles, such as styrene resin particles, silicone resin particles, acrylic resin particles and MS resin particles (methacryl-styrene copolymer particles) and inorganic particles, such as barium sulfate particles, glass particles, aluminum hydroxide particles, calcium carbonate particles, silica particles (silicon dioxide particles), titanium oxide particles and glass beads. The support member 14 may contain one or some of those diffusing materials.

Preferably, the difference between the refractive index of the diffusing material 42 and that of the resin forming the support member 14 is 0.1 or below, more preferably, 0.03 or below. When the difference between the respective refractive indices of the diffusing material 42 and the resin forming the support member 14 meets this condition, contrast is not deteriorated. The diffusing material 42 and the resin forming the support member 14 are selected so that the difference in refractive index between the diffusing material 42 and the resin meets the foregoing condition. For example, a MS resin having a refractive index of 1.51 is used for forming the support member 14 and an acrylic resin having a refractive index of 1.49 is used as the diffusing material 42 in combination.

There are not particular restrictions on the shape of particles of the diffusing material 42. Usually, particles of the diffusing material 42 having a spherical shape or a substantially spherical shape are easily available. Preferably, the mean particle size of particles of the diffusing material 42 is between 5 and 30 μm.

The diffusing sheet 41 in the fourth embodiment, similarly to the diffusing sheet 11 in the first embodiment and the diffusing sheet 21 in the second embodiment, has the exit surface 12 facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Thus the diffusing sheet 21 is glossy and is capable of displaying images in satisfactory contrast.

### Diffusing Sheets in Fifth and Sixth Embodiments

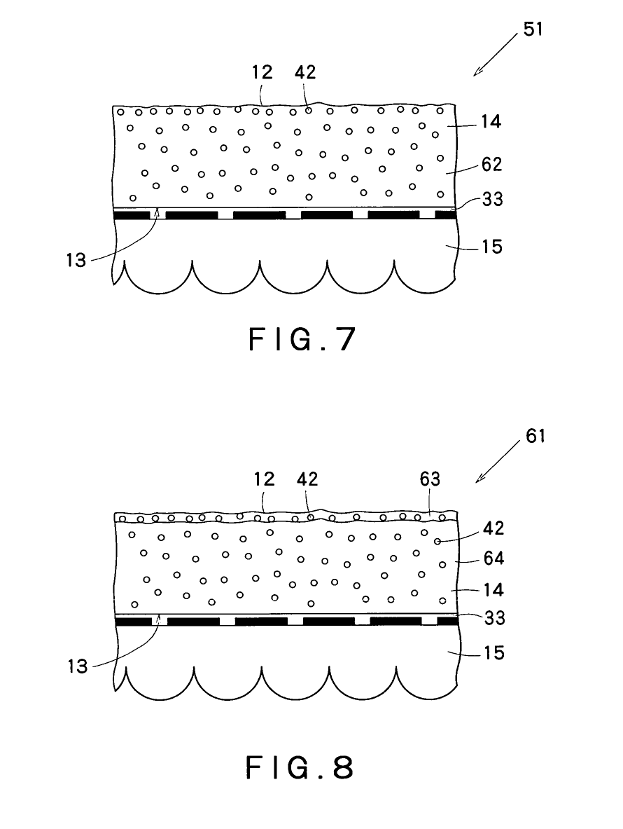

FIGS. 7 and 8 are typical sectional views of a diffusing sheet 51 in a fifth embodiment according to the present invention and a diffusing sheet 61 in a sixth embodiment according to the present invention, respectively.

The diffusing sheet 51 in the fifth embodiment and the diffusing sheet 61 in the sixth embodiment are similar to the diffusing sheet 11 in the first embodiment and the diffusing sheet 21 in the second embodiment. The diffusing sheet 51 in the fifth embodiment and the diffusing sheet 61 in the sixth embodiment have exit surfaces 12 facing the viewer and parts near the exit surfaces 12 containing a diffusing material 42. The diffusing sheet 51 in the fifth embodiment has a support member 14 including a single resin layer 62. The diffusing sheet 61 in the sixth embodiment has a support member 14 including two resin layers 63 and 64.

In each of the diffusing sheets 51 and 61, at least either a surface layer having the exit surface 12 or a layer contiguous with the surface layer contains the diffusing material 42. The diffusing material 42 does not necessarily need to be dispersed in the entire support member 14. Preferably, the surface roughness of the exit surfaces 12 of the diffusing sheets 51 and 61 is determined by the diffusing material 42. The surface roughness meeting the condition specified by the present invention is dependent on the diffusing material 42 contained in either the surface layer having the exit surface or the layer contiguous with the surface layer. Thus at least protrusions in the exit surface are particles of the diffusing material 42.

Measurement of the surface roughness of the exit surface 12 facing the viewer and the discrete Fourier transform of measured data are the same as those mentioned in connection with the description of the diffusing sheets in the first and the second embodiment.

The diffusing sheet 51 in the fifth embodiment and the diffusing sheet 61 in the sixth embodiment, similarly to the diffusing sheet 11 in the first embodiment and the diffusing sheet 21 in the second embodiment, have the exit surfaces 12 facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Thus the diffusing sheet 21 is glossy and is capable of displaying images in satisfactory contrast.

Method of Fabricating Diffusing Sheet

The foregoing diffusing sheets of the present invention can be fabricated by various methods. For example, the support member 14 can be made by processing a resin by extrusion molding, injection molding or press molding. A diffusing material having a predetermined particle size is added to the resin for forming the support member 14 in a predetermined content so that the exit surface 12 facing the viewer may have the foregoing feature of the present invention. The support member 14 having the exit surface 12 having the desired surface roughness may be formed by extrusion molding using an extrusion roller having a surface shaped in the desired surface roughness, by injection molding using an injection mold having a molding surface having the desired surface roughness for forming the exit surface 12 or by press molding using a press die having a pressing surface having the desired surface roughness for forming the exit surface 12. The surface of the extrusion roller, the molding surface of the injection mold and the shaping surface of the press die can be formed in a desired surface roughness by a sand-blasting process, a polishing process or a chromium plating process. Thus the exit surface 12 of the support member 14 can be formed in a desired surface roughness. The shaping surface of the mold having the properly adjusted surface roughness meets a condition that a value obtained by dividing a value obtained through the discrete Fourier transform of roughness data obtained by measuring the surface roughness of the exit surface by the number of data is 0.04 μm or below for frequencies of 80 mm⁻¹ or above.

The support members 14 thus formed are bonded to the diffusing members 15 and 22, respectively, with the adhesive 33. The adhesive 33 is an adhesive generally used for bonding optical sheets, such as an ultraviolet-curable adhesive or an adhesive resin.

Rear Projection Screen and Rear Projection Display

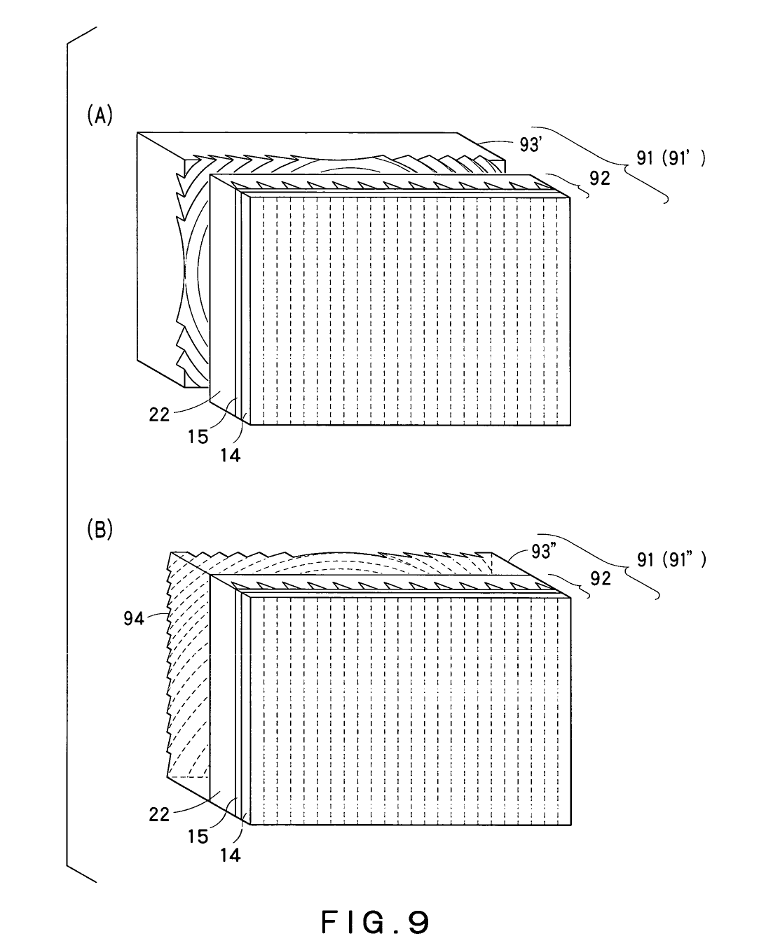

FIG. 9 shows rear projection screens 91 according to the present invention by way of example. FIG. 9(A) shows a rear projection screen 91′ provided with a refraction type Fresnel lens sheet 93′ having a Fresnel lens on an inner surface thereof. FIG. 9(B) shows a rear projection screen 91″ provided with a total reflection type Fresnel lens sheet 93″ having a Fresnel lens on an outer surface thereof. The rear projection screen of the present invention 91 (91′ or 91″) includes the diffusing sheet 92 and a Fresnel lens sheet 93 (93′ or 93″). The diffusing sheet 92 is any one of the diffusing sheets in the first to the sixth embodiment.

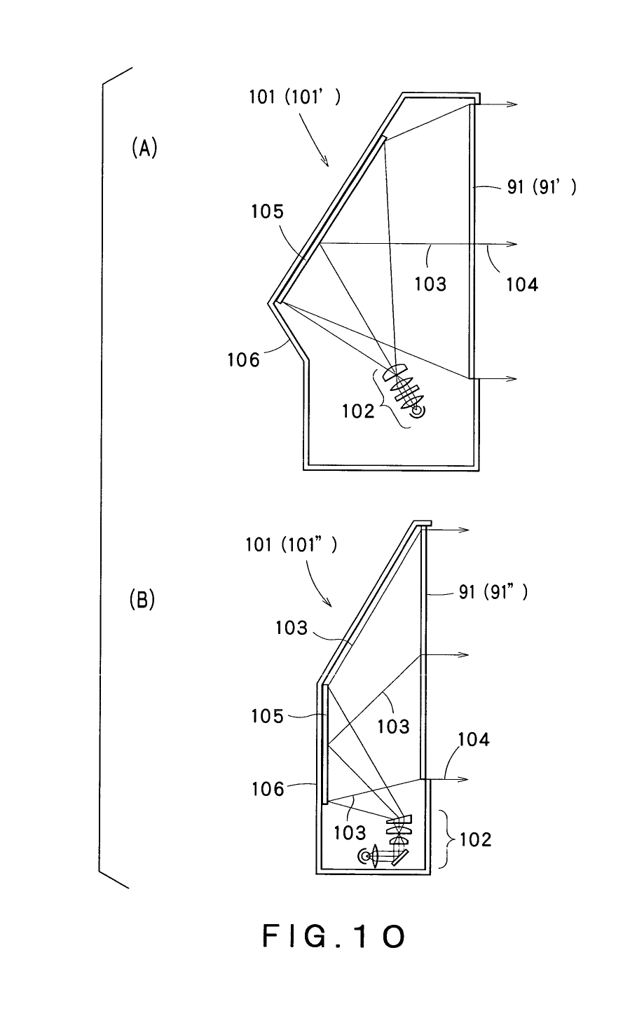

The Fresnel lens sheet 93 of the rear projection screen 91 (91′ or 91″) is on the side of a video source. The Fresnel lens sheet 93 (93′ or 93″) collimates image light rays projected by the video source in substantially parallel light rays falling on the diffusing sheet 92 on the side of the viewer. The Fresnel lens sheet 93 (93′ or 93″) may be any Fresnel lens sheet having such a collimating function. For example, the Fresnel lens sheet 93 may be the refraction type Fresnel lens sheet 93′ shown in FIG. 9(A) provided with the Fresnel lens on the inner surface thereof and suitable for use in a rear projection display 101′ shown in FIG. 10(A) or may be the total reflection type Fresnel lens sheet 93″ shown in FIG. 9(B) provided with the Fresnel lens on the outer surface thereof and suitable for use in a rear projection display 101″ shown in FIG. 10(B). The total reflection type Fresnel lens sheet 93″ is provided with a Fresnel lens 94 having total reflection faces that reflects image light rays fallen on refracting faces in a total reflection mode. A Fresnel lens sheet having a part provided with a total reflection type Fresnel lens may be used.

The diffusing sheet 92 may be any one of the diffusing sheets in the first to the sixth embodiment. The diffusing sheet 92 diffuses substantially parallel light rays coming from the Fresnel lens sheet 93 to increase viewing angle. The diffusing sheets 92 shown in FIGS. 9(A) and 9(B) are provided with the diffusing member 22, having the light guide function, of the diffusing sheet in the second embodiment. In each of the diffusing sheets 92 shown in FIGS. 9(A) and 9(B), the support member 14, an adhesive layer 95 and the diffusing member 22 are arrange in that order from the side of the viewer.

The rear projection screen 91 diffuses the light rays projected by the video source in a predetermined angular range. Therefore, an image displayed on the rear projection screen 91 can be satisfactorily seen from a position horizontally displaced from a position right in front of the rear projection screen 91.

The rear projection screen 91 is provided with the diffusing sheet having the exit surface meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above. Therefore the rear projection screen 91 is glossy and has an effect of displaying images in satisfactory contrast. Thus the rear projection screen 91 is suitable for use in a rear projection display provided with a single light source, such as a LCD or a DLR The rear projection screen 91 is glossy and is capable of displaying images in satisfactory contrast.

FIG. 10 shows rear projection displays 101 (101′ and 101″) provided with the rear projection screen of the present invention by way of example. The rear projection display 101′ shown in FIG. 10(A) includes the rear projection screen 91″ having the refraction type Fresnel lens sheet 93′ provided with the Fresnel lens on an inner surface thereof. The rear projection display 101″ shown in FIG. 10(B) includes the rear projection screen 91″ having the total reflection type Fresnel lens sheet 93″ provided with the Fresnel lens on an outer surface thereof.

The rear projection display 101 (101′ or 101″) is provided with the rear projection screen 91 (91′ or 91″) of the present invention. The rear projection display 101 includes a comparatively thin box 106, a video source 102 disposed in a bottom part of the box 106 and a mirror 105 disposed near the inner surface of the back wall of the box 106 and perpendicularly extending into the paper. The rear projection screen 91 is placed in a window formed in the front wall of the box 106.

Image light rays 103 projected by the video source 102 are reflected toward the rear projection screen 91 by the mirror 105. The Fresnel lens sheet collimates the image light rays incident on the rear projection screen 91 so that the image light rays are substantially parallel. The diffusing sheet diffuses the parallel image light rays into diffused light rays 104. The diffused image light rays 104 travel from the rear projection screen 9d1 toward the viewer.

### EXAMPLES

Examples of the present invention and comparative examples will be described.

### Example 1

A support member and a diffusing member were bonded together to form a diffusing sheet for a rear projection screen. A support sheet was made by processing a MS resin by an extrusion molding process. The MS resin contained about 1 to about 2% by weight MS resin diffusing particles of particle sizes in the range of about 10 to about 20 μm. A surface of the support sheet was coated with an about 10 μm thick hard coat of an antistatic acrylic resin containing about 10% by weight particles of a crosslinkable acrylic resin, namely, a diffusing material, of particle sizes in the range of about 10 to about 20 μm to obtain the support member 14. The exit surface of the hard coat of the support member 14 had a value, obtained by dividing a value obtained through the discrete Fourier transform of roughness data obtained by measuring the surface roughness of the exit surface by the number of data, not greater than 0.04 μm for frequencies of 80 mm⁻¹ or above.

A lenticular lens shaping die was used for forming the diffusing member 15. The lenticular lens shaping die had grooves having a cross section substantially corresponding to a cross section of a cylindrical lens resembling the half of an ellipse having a major axis of 80 μm×2 in length and a minor axis of 40 μm×2 in length arranged at pitches of 150 μm. The shaping surface of the lenticular lens shaping die was coated with an ultraviolet-curable resin, a 100 μm thick PET film was attached to the shaping surface coated with the ultraviolet-curable resin and the ultraviolet-curable resin was irradiated with ultraviolet rays to complete the diffusing member 15 provided with lenticular lenses. The BS strips were formed at intervals on the exit surface of the diffusing member 15 so that the BS strips and transparent parts were arranged alternately. The width of the transparent parts was 100 μm and the width of the BS strips was 50 μm. Respective pitches of the transparent parts and the BS strips were equal to the pitches of 150 μm of the lenticular lenses.

The support member and the diffusing member were bonded together with an ultraviolet-curable acrylic adhesive to complete the diffusing sheet 11 in the first embodiment. The entrance surface, the surface roughness of which was not adjusted, of the support member and the exit surface, provided with the BS strips, of the diffusing member were bonded together.

### Example 2

A diffusing sheet in Example 2 was fabricated by a method similar to that of fabricating the diffusing sheet in Example 1. A diffusing member included in the diffusing sheet in Example 2 was different from that included in the diffusing sheet in Example 1.

The diffusing member of the diffusing sheet in Example 2 is similar to the diffusing member 22 shown in FIG. 4. A shaping die provided with grooves arranged at pitches of 70 μm was used for shaping a diffusing member of about 150 μm in thickness, namely, the distance between the exit surface 19 and the entrance surface 20. The shaping surface of the shaping die was coated with an ultraviolet-curable resin, a 100 μm thick PET film was attached to the shaping surface coated with the ultraviolet-curable resin and the ultraviolet-curable resin was irradiated with ultraviolet rays to cure the ultraviolet-curable resin to obtain a sheet provided with V grooves. The sheet provided with the V grooves was removed from the shaping die. The V grooves of the sheet was filled up with a resin containing about 20% by weight diffusing particles (Urethane filler particles containing carbon of particle sizes in the range of about5 3 to about 10 μm) to complete the diffusing member 22. The width of transparent parts 2 was 30 μm. The width of the grooves on the exit surface was 40 μm. Respective pitches of the transparent parts and the grooves were 70 μm.

### Example 3

The diffusing sheet in Example 3 was fabricated by the same method as that of fabricating the diffusing sheet in Example 1, except that a support member was made by the following processes.

A support film was made by extruding a MS resin by an extrusion molding method. The support film was made of a resin containing about 1 to about 2% by weight diffusing particles of a plurality of types of MS resins having particle sizes in the range of about 10 to about 20 μm. A surface of a 100 μm thick PET film was coated with an ultraviolet-curable resin containing about 10% by weight diffusing particles (silica filler having particle sizes in the range of about 2 to about 10 μm) and the ultraviolet-curable resin was cured. The PET film thus prepared was bonded to a surface of the support film to obtain an about 2 mm thick support member 14. The surface of the support member had a value, obtained by dividing a value obtained through the discrete Fourier transform of roughness data obtained by measuring the surface roughness of the exit surface by the number of data, not greater than 0.04 μm for frequencies of 80 mm⁻¹ or above.

### Comparative Example 1

A diffusing sheet in Comparative example 1 was fabricated by the same method as that of fabricating the diffusing sheet in Example 1, except that a support member included in the diffusing sheet in Comparative example 1 was made by the following processes.

The support member was made by processing a support film formed by extruding a MS resin by an extrusion molding method. A resin forming the support film contained about 1 to about 2% by weight diffusing particles of particle sizes in the range of about 10 to about 20 μm of a plurality of types of MS resins. A 100 μm thick PET film was attached to an ultraviolet-curable resin layer formed on a molding surface finished by sandblasting using sand of #320 and the ultraviolet-curable resin layer was cured. The PET film having the ultraviolet-curable resin layer was attache to the support film to obtain an about 2 mm thick support member. The surface of the support member had a value, obtained by dividing a value obtained through the discrete Fourier transform of roughness data obtained by measuring the surface roughness of the exit surface by the number of data, exceeding 0.04 μm for frequencies of 80 mm⁻¹ or above.

### Comparative Example 2

A diffusing sheet in Comparative example 2 was fabricated by the same method as that of fabricating the diffusing sheet in Example 1, except that a support member included in the diffusing sheet in Comparative example 2 was made by the following processes.

The support member was made by processing a support film formed by extruding a MS resin by an extrusion molding method. A resin forming the support film contained about 1 to about 2% by weight diffusing particles of particle sizes in the range of about 10 to about 20 μm of a plurality of types of MS resins. An ultraviolet-cured resin film was attached to the support film to obtain an about 2 mm thick support member. The ultraviolet-cured film was made by attaching a 100 μm thick PET film to an ultraviolet-curable resin layer formed on a molding surface finished by sandblasting using glass beads of #100 and curing the ultraviolet-curable resin layer. The surface of the support member had a value, obtained by dividing a value obtained through the discrete Fourier transform of roughness data obtained by measuring the surface roughness of the surface by the number of data, exceeding 0.04 μm for frequencies of 80 mm⁻¹ or above.

Measurement and Measured Data

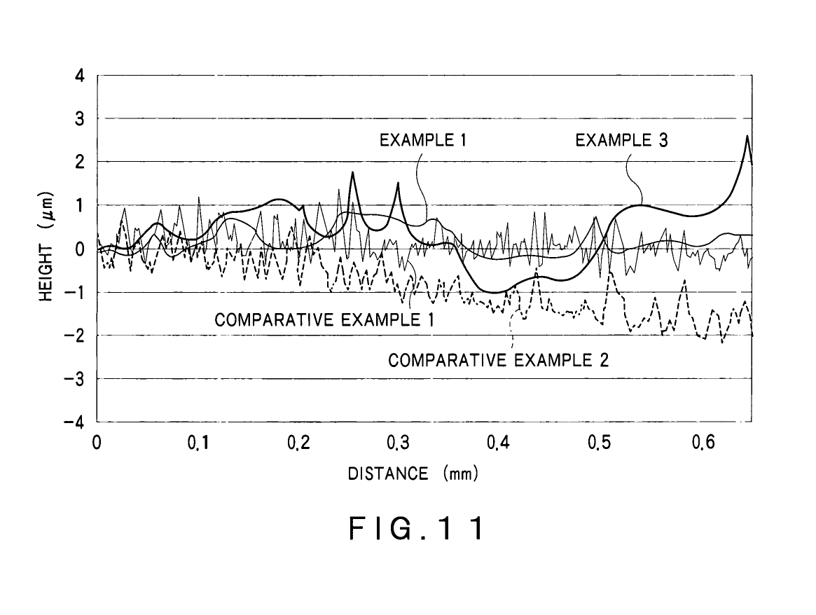

The respective surface roughnesses of the exit surfaces of the diffusing sheets in Examples 1 to 3 and Comparative examples 1 and 2 were measured. FIG. 11 shows surface roughness curves of the respective surface roughnesses of the exit surfaces of the diffusing sheets in Examples 1 and 2 and Comparative examples 1 and 2 measured by a surface roughness measuring method specified in B0601 JIS and ISO 4287-1997. A Surface roughness was measured by a contact profile meter (Surfcom 130A, Tokyo Seimitsu K.K.), in which measuring speed was 0.3 mm/min, cutoff was 0.25 mm, measuring length was 10 mm and the number of measured data was 3,1207 points. Two thousand points of the measured data was subjected to discrete Fourier transform. Table 1 shows the arithmetical average surface roughnesses of the surfaces.

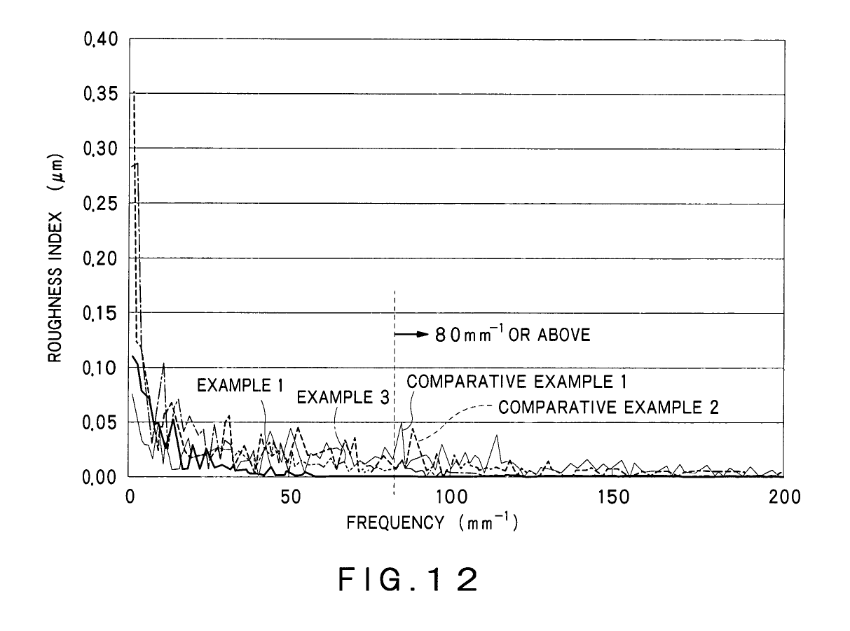

FIG. 12 shows curves of values each obtained by dividing a value obtained through the discrete Fourier transform of the roughness data shown in FIG. 11 by the number of data. The two thousand pieces of data were used for calculation for discrete Fourier transform using Expressions (4) and (5).

The diffusing sheets in Examples 1 to 3 and Comparative examples 1 and 2 were combined with Fresnel lens sheets to obtain rear projection screens (FIG. 9(A)). Each of the Fresnel lens sheet was made by forming a Fresnel lens of an ultraviolet-curable epoxy acrylate resin on a polyester film. The rear projection screens thus fabricated were tested on a 50 in. rear projection television similar to the rear projection display shown in FIG. 10(A). The rear projection television included a LCD light source provided with a projection lens having a pupil diameter of 33 mm. Projection distance was 750 mm and the illuminance on the entrance surface of the rear projection screen was 120 lx. The rear projection screens were evaluated for glossiness, contrast and reflection of external light through sensory test (visual test).

Gloss was evaluated visually. Surface with a quiet, elegant gloss were marked with a circle and unglossy surfaces were marked with a cross. Glossiness was measured and evaluated by a method specified in Z8741 JIS. A glossiness G(60°) is the ratio in percentage of the intensity of light reflected by a surface of a test rear projection screen to that of light fallen on a surface of a glass plate having a refractive index of 1.567 at an incident angle of 60° and reflected by the surface of the glass plate. Contrast was evaluated visually. Surfaces having a proper black level for televisions were marked with a circle and surfaces not having a proper black level were marked with a cross. Reflection of external light was evaluated visually. Rear projection screens as applied to a rear projection television having an optimum property with respect to reflection of external light were marked with a double circle and those having a satisfactory property with respect to reflection of external light were marked with a circle. Overall performance judgment of the rear projection screens provided with the diffusing sheet was made through the evaluation of the overall performance of the rear projection screens as used on a television. The rear projection screens having a satisfactory performance were marked with a circle and those not having a satisfactory performance were marked with a cross. Results of evaluation are shown in Table 1.

Table 1

1 . . . Roughness index (μm), 2 . . . Arithmetical average roughness Ra (μm), 3 . . . Gloss/Glossiness, 4 . . . Contrast, 5 . . . Reflection of external light, 6 . . . Overall performance, 7 . . . Example 1, 8 . . . Comparative example 1, 9 . . . ≦0.04, 10 . . . >0.04, 11 . . . *) Roughness index is a value obtained by dividing a value obtained through the discrete Fourier transform of measured roughness data by the number of data for frequencies of 80 mm⁻¹ or above.

As obvious from the results of evaluation of the appearance of the rear projection screens respectively provided with the diffusing sheets in Examples 1 to 3 and Comparative examples 1 and 2, the rear projection screens respectively provided with the diffusing sheets in Examples 1 to 3 have a high glossiness and external light was reflected weakly in the surfaces thereof. Each of the surfaces of the diffusing sheets in Examples 1 to 3 had a value obtained by dividing a value obtained through the discrete Fourier transform of roughness data obtained by measuring the surface roughness thereof by the number of data not greater than 0.04 μm for frequencies of 80 mm⁻¹ or above. The diffusing sheets in Examples 1 and 2 are similar in construction and hence are similar in performance as shown in Table 1.

External light was reflected scarcely in the rear projection screens provided respectively with the diffusing sheets in Comparative examples 1 and 2. Although the surface roughnesses of the diffusing sheets in Comparative examples 1 and 2 were in the range of the surface roughnesses of the diffusing sheets in Examples 1 to 3, the diffusing sheets in Comparative examples 1 and 2 were not glossy and the contrast of images displayed on the rear projection screens provided with the diffusing sheets in Comparative examples 1 and 2 was unsatisfactory. Parts of the surfaces of the diffusing sheets in Comparative examples 1 and 2 had a value obtained by dividing a value obtained through the discrete Fourier transform of roughness data obtained by measuring the surface roughness thereof by the number of data greater than 0.04 μm for frequencies of 80 mm⁻¹ or above.

It is known from the results of evaluation that the rear projection screens provided respectively with the diffusing sheets in Examples 1 to 3 and having a glossy surface are excellent in respect of contrast even though external light is reflected slightly therein. The rear projection screens provided respectively with the diffusing sheets in Comparative examples 1 and 2 have a matte, whitish appearance and are unsatisfactory in contrast. It was known that contrast is not greatly dependent on the arithmetical average roughness Ra of the exit surface.

It was found that a surface does not have many small irregularities, does not cause excessive irregular reflection of light and has an improved gloss when the surface has a value obtained by dividing a value obtained through the discrete Fourier transform of roughness data obtained by measuring the surface roughness thereof by the number of data not greater than 0.04 μm for frequencies of 80 mm⁻¹ or above.

1. A diffusing sheet, for a rear projection screen, having an exit surface facing the viewer and meeting a condition that a value obtained by dividing a value obtained through the discrete Fourier transform of roughness data obtained by measuring the surface roughness of the exit surface by the number of data is 0.04 μm or below for frequencies of 80 mm⁻¹ or above.

2. The diffusing sheet according to claim 1, wherein the exit surface has an arithmetical average roughness Ra of 0.50 μm or below.

3. The diffusing sheet according to claim 1, wherein the exit surface is coated with a transparent layer having an arithmetical average roughness Ra of 0.05 μm or below.

4. The diffusing sheet according to claim 1, wherein at least a layer including the exit surface or a layer contiguous with the former layer contains a diffusing material.

5. The diffusing sheet according to claim 4, wherein the surface roughness of the exit surface is determined by the diffusing material contained in at least in a layer including the exit surface or a layer contiguous with the former layer.

6. The diffusing sheet according to claim 1 comprising a support member having the exit surface, and a diffusing member attached to the entrance surface of the support member opposite the exit surface.

7. The diffusing sheet according to claim 6, wherein the diffusing member is provided with transparent parts and screening strips in an alternate arrangement on the exit surface thereof facing the support member, and provided with lenses for focusing substantially parallel incident light rays falling in a direction parallel to a normal to the diffusing member in the vicinity of the transparent parts on the entrance surface thereof opposite the exit surface thereof.

8. The diffusing sheet according to claim 6, wherein the diffusing member is provided with light absorbing parts of a substantially V-shaped cross section each having a first inclined surface and a second inclined surface, formed in the exit surface thereof contiguous with the support member and tapering toward the entrance surface thereof, and parts thereof other than the light absorbing parts have a refractive index higher than that of the light absorbing parts, and the first and the second inclined surfaces serve as light guides for totally reflecting substantially parallel incident light rays fallen on the entrance surface.

9. A rear projection screen comprising the diffusing sheet set forth in claim 1.
